(19) United States
(12) Patent Application Publication
(10) Pub. No.: US 2019/0001504 A1
(43) Pub. Date: Jan. 3, 2019

(54) Method For Detecting A Collision Of A Robot Arm With An Object, And A Robot With A Robot Arm

(71) Applicant: KUKA Deutschland GmbH, Augsburg (GB)

(72) Inventors: Yevgen Kogan, Augsburg (DE); Steffen Walther, München (DE)

(21) Appl. No.: 15/781,927

(22) PCT Filed: Dec. 1, 2016
(86) PCT No.: PCT/EP2016/079477

§ 371 Date: Jun. 6, 2018

(30) Foreign Application Priority Data
Dec. 8, 2015 (DE) 10 2015 224 641.8

(51) Int. Cl. B25J 13/08; B25J 9/16; B25J 9/04

(52) U.S. Cl. CPC B25J 13/088; B25J 9/1676; B25J 9/047; B25J 9/1651

(57) ABSTRACT

A method for detecting a collision of a robot arm with an object and a correspondingly configured robot. The robot arm is a part of the robot and includes a plurality of serially arranged links mounted relative to respective axes, and position sensors allocated to the individual axes are provided for determining the poses of any two adjacent links relative to one another. The robot further includes an electronic control device connected to the positioning devices, and actuators controlled by the electronic control device for automatically moving the links. The method includes evaluating whether at least one invariant for a target movement of the robot arm is satisfied by an actual movement of the robot arm and, when the evaluation results in a non-satisfaction of the at least one invariant, then indicating a collision of the robot arm with the object and initiating a safety function of the robot.

### CROSS-REFERENCE

This application is a national phase application under 35 U.S.C. § 371 of International Patent Application No. PCT/EP2016/079477, filed Dec. 1, 2016 (pending), which claims the benefit of German Patent Application No. DE 10 2015 224 641.8 filed Dec. 8, 2015, the disclosures of which are incorporated by reference herein in their entirety.

### TECHNICAL FIELD

The invention relates to a method for the detection of a collision of a robot arm with an object and an accordingly formed robot comprising a robot arm and an electronic controlling device.

### BACKGROUND

Robots are generally handling machines, which for the purpose of independently handling objects are equipped with expedient tools, so-called end effectors, and can be programmed in multiple movement axes in particular with respect to orientation, position, and workflow for an automated execution of a work task. Robots comprise a robot arm with multiple links arranged one behind the other and programmable controls (controlling devices), which control the actuators of the robot for the movement sequences of the robot arm during an automatic operation of the robot. For this purpose, corresponding computation programs, so-called user programs, run on the control devices.

DE 10 2004 026 185 A1 discloses a robot with a robot arm to which an inertial sensor is fastened. This sensor supplies movement-characteristic measurement values. A path section is monitored while running through a reference drive, in order to continuously determine movement-characteristic measurement values, which are stored as reference values.

EP 0 365 681 A1 discloses a method for detecting a collision of a robot arm with an object through the evaluation of electric currents of the electric motors provided for moving the robot arm.

### SUMMARY

The object of the present invention is to provide an improved method for detecting a collision of a robot arm with an object. A further object of the invention is to provide an accordingly configured robot.

The object of the invention is achieved by a method for the detection of a collision of a robot arm with an object, where the robot arm is a part of a robot comprising multiple links, arranged one behind the other and mounted rotatably relative to the axes, and position sensors allocated to the individual axes provided for the purpose of determining the poses of any two neighboring links relative to one another, where in particular a Tool Center Point is allocated to the robot arm, and the robot comprises an electronic control device connected to the positioning devices and also comprises actuators controlled by the electronic control device for the automatic movement of the links of the robot arm relative to one another, comprising the following process steps:

controlled by the electronic control device, automatic movement of the links, such that the robot arm performs an actual movement that is allocated to a target movement of the robot arm,

during the actual movement of the robot arm, using the electronic control device and based upon the signals emitted by the position sensors, check of whether at least one applicable invariant for the target movement of the robot arm is fulfilled based upon the actual poses and/or derived values of the actual poses of the links relative to one another, and/or based upon the actual position and/or at least one derived value of the actual position of the Tool Center Point,

indication of a collision of the robot arm with the object if the check results in a non-fulfillment of the at least one invariant, and subsequently

controlled by the electronic control device, initiation of a safety function of the robot.

The further object of the invention is solved by a robot comprising a robot arm to which in particular a Tool Center Point is allocated, and which comprises multiple links arranged one behind the other and mounted relative to the axes and position sensors allocated to the individual axes provided for the purpose of determining the poses of any two neighboring links relative to one another, an electronic control device connected to the positioning devices, and actuators controlled by the electronic control device for the automatic movement of the links of the robot arm relative to one another, where the electronic control device is configured such that the robot performs the inventive method.

The robot comprises the electronic control device and the robot arm. The electronic control device is configured to control the actuators of the robot arm such that the robot arm [and] thus the links of the robot arm perform a corresponding movement. In doing so, the Tool Center Point of the robot arm may move along a corresponding target path. For this purpose, for example, a corresponding computation program runs on the electronic control device. During this automatic movement, the Tool Center Point may automatically move along an actual path.

The actuators are preferably electric actuators, in particular controlled electric actuators. In particular, at least the electric motors of these electric actuators are fastened in or on the robot arm.

The robot arm comprises the multiple links arranged one behind the other, which are mounted relative to the axes, and the position sensors. The links are preferably mounted rotatably relative to the axes. The position sensors are preferably resolvers. The position sensors are preferably executed in so-called safe technology and are connected to the electronic control device such that the electronic control device is able to evaluate the signals emitted by the position sensors.

Using the position sensors, it is possible for the electric control device to determine the current poses, i.e. the actual poses of the individual links, during the actual movement relative to one another. Based upon the actual poses, it is also possible for the electronic control device to determine the current position and location, i.e. the actual position and actual location, of the Tool Center Point during the automatic movement. The location of the Tool Center Point is its position and its orientation in the frame.

If the links are mounted rotatably relative to the axes, then the poses of the links relative to one another are corresponding angular poses.

Further, it is possible for the electronic control device to determine derived values of the actual position and the actual poses.

Derived values of the actual position of the Tool Center Point are, in particular, time rates of change and derivations of the actual position according to time, such as the velocity, the acceleration, or also higher derivations of the actual position according to time.

Derived values of the actual poses are, for example, time rates of change and derivations of the actual angle poses according to time or also higher derivations of the actual angle poses according to time.

During the automatic actual movement using the electronic control device and based upon the signals emitted by the position sensors, there is an inventive check of whether, based upon the actual poses and/or derived values of the actual poses and/or based upon the actual position and/or the at least one derived value of the actual position of the Tool Center Point, the at least one invariant for the target movement of the robot arm for the current movement, i.e. the actual movement of the robot arm, is fulfilled.

As known from information technology, an invariant is a statement that applies across the execution of certain program commands. It is thus true before, during, and after the program commands. It is therefore unchanging, i.e. invariant. Therefore, this means that the invariant allocated to the target movement of the robot arm, i.e. the one allocated to the respective true statement regarding the target movement of the robot arm, is checked for whether it is fulfilled by the current movement allocated to the actual movement of the robot arm.

If the invariant is not fulfilled by the actual movement, which is detected by the check of the actual poses and/or the derived values of the actual poses, and/or based upon the actual position, and/or the at least one derived value of the actual position of the Tool Center Point, then a collision with the object is indicated. Subsequently, the electronic control device initiates a safety function of the robot. One example of a safety function is an immediate stopping of the movement of the robot arm, for example within the scope of a so-called “Emergency Stop.”

For the purpose of detecting collisions, position sensors are thus used, which are fastened, for example, drive-side and/or driven-side on the robot arm relative to the respective actuators. The position sensors are preferably executed in safe technology. In particular, additionally or alternatively, values that are derived from the signals of the positions sensors can be considered. These are, in particular, velocity, acceleration, and “jerking,” i.e. the time derivative of the acceleration.

In particular, the measured data and the signals from the position sensors, in combination with the assumptions regarding the invariants, are used during the performance of the movement in order to indicate a collision.

In one embodiment, the assumption that movements are planned to be jerk-free, for example by the electronic control device, can be used as the invariant. This means that during the normal performance of the movement, no jumps should appear in the velocity signals. A jump would indicate a sudden change in the acceleration, i.e. a jerk. Now, if a jerk appears during a movement that has been planned to be jerk-free, a collision is indicated. If position sensors are used that have been executed in safe technology, then all information derived from them (velocity, acceleration, jerking) is certainly available.

According to one embodiment of the inventive method, the invariant indicates that the target movement is jerk-free. Then, a collision of the robot arm with the object is indicated if the third derivation of the actual position of the Tool Center Point according to time or a time rate of change of the actual acceleration of the Tool Center Point exceeds a predetermined value. Alternatively, it is also possible that a collision of the robot arm with the object is indicated if the third derivations of the actual poses of the links relative to one another according to time, or a time rate of change of the actual accelerations of the actual poses of the links relative to one another exceed a predetermined value.

In a further embodiment of inventive method, assumed values can be subtracted from the measured values (e.g. target velocities, target accelerations from a physical model). The result of the subtraction can be checked against a threshold, i.e. the predetermined value.

The profile of the values measured using the position sensors can also be recorded. Through comparison of the current profile, i.e. in particular of the profile of the actual movement with recorded values, i.e. in particular of the profile of the target movement, a collision can also be indicated in the case of deviations.

Additionally, control parameters for a controlling of the robot can also be used for the detection of a collision. For example, the deviation, in particular the detectable jerking, will change with a rigidity of an implemented control.

According to one embodiment of the inventive method, the robot arm is operated using an admittance or force control, and the invariant indicates that the movement allocated to the target path is jerk-free. In this case, it may be provided that a collision of the robot arm with the object is indicated if the third derivation of the actual position of the Tool Center Point according to time or a time rate of change of the actual acceleration of the Tool Center Point exceeds a predetermined value, or if the third derivations of the actual poses of the links relative to one another according to time or a time rate of change of the actual accelerations of the actual poses of the links relative to one another exceed a predetermined value, where the predetermined value depends upon the rigidity of the admittance or force control.

The electronic control device can be configured such that it comprises a first control functionality and second control functionality. The first control functionality undertakes the object of a safety control, and the second control functionality undertakes the remaining controls of the robot.

The first control functionality i.e. the safety control is provided for a realization of safety-oriented functionalities, such as stop reactions. For the safety control, data and signals are required that have been produced in safe technology. This can be realized through the use of a sensor system in safe technology.

Further data, however, can be obtained on the basis of non-safe technology. Data used or produced for a control, for example, do not fulfill the criterion of safe data. These data are used, for example, for the current movement of the robot arm. These data and information thus cannot be evaluated in the safety control, because they originate from, for example, the non-safe user program. In some cases, however, it is nonetheless possible, on the basis of available safe data regarding assumptions/models, to also obtain the information in safe technology that is otherwise only available in the non-safe control. A few examples are described in the following.

For controlling a robot, interpolation types such as “PTP” or “LIN” can be used. “PTP” is an acronym for “Point to Point,” and “LIN” is an acronym for “Linear.” In both cases, these are straight i.e. linear paths (PTP: Straight in the so-called axis frame, LIN: Straight in the Cartesian frame).

Thus, according to one variant of the inventive method, a linear movement of the Tool Center Point can be allocated to the target path.

In this case, if the distance between an actual position and the straight lines allocated to the target path is greater than a threshold i.e. predetermined value, then a collision is indicated.

According to one embodiment of the inventive method, the at least one invariant is allocated to the target position of the Tool Center Point during the target movement. Then, it can be provided that during the actual movement of the Tool Center Point, the actual positions of the Tool Center Point are checked, and the invariant is then not fulfilled as soon as at least one of the actual positions of the corresponding target position of the Tool Center Point deviates by a predetermined value. The target positions are preferably calculated within the safe control based upon the invariant.

According to a further embodiment of the inventive method, the at least one invariant is allocated to the target poses of the links relative to one another during the target movement. Then, it can be provided that during the actual movement of the robot arm the actual poses of the links relative to one another are checked, and the invariant is then not fulfilled if at least one of the actual poses of the corresponding target pose deviates by a predetermined value.

These facts can be exploited for collision detection, in particular, in multiple ways.

The target movement can be determined for example using a path planning performed by the electronic control device. This path planning is performed, in particular, using the second control functionality.

According to this embodiment, it can be provided that the second control functionality transmits a notification to the first control functionality that a planned linear target movement is imminent. This notification comprises, in particular, information about the target start and target end point of the Tool Center Point, whereby the first control functionality receives as an invariant the notification that the target positions of the Tool Center Point of the imminent target movement will run on the straight lines determined by the target start and target end points. If at least one of the actual positions deviates from this straight line by the predetermined value during the actual movement of the robot arm, then the first control functionality identifies the collision. The straight line can also be indicated by another description known from mathematics.

In addition to the collision detection, there is also the possibility of detecting an erroneous performance of the movement of the robot arm, i.e. also in the event that no collision has appeared but the robot arm does not move as expected. One example is when, if the Tool Center Point is intended to move along a linear path, at least one actual position of the Tool Center Point deviates from the corresponding straight line too greatly.

It can also be provided that the electronic control device, in particular its first control functionality, evaluates the movement of the Tool Center Point at the start of a movement, in order to obtain through extrapolation of this movement the target movement and an invariant allocated to the target movement.

In this case, it can be provided that no information is exchanged between the first and second control functionalities. At the start of the performance of the movement, for example in an acceleration phase, the first control functionality can record the actual positions of, for example, the Tool Center Point, during a preferably predetermined period of time and extrapolate from this the future target movement of the robot arm. The basis of the extrapolation can be a notification of which types of paths are possible in principle, for example linear paths or circular paths.

The extrapolation should preferably be completed before the velocity of the Tool Center Point becomes so high that potential collisions become dangerous.

According a further variant of the inventive method, the at least one invariant is allocated to a constant target velocity of the Tool Center Point during its movement. During the movement of the Tool Center Point along an actual path, the actual velocity and/or the actual acceleration of the Tool Center Point can then be determined and evaluated as at least one derived value of the actual position of the Tool Center Point. The invariant is then not fulfilled if the actual velocity of the Tool Center Point deviates by a predetermined value and/or the quantity of the actual acceleration of the Tool Center Point exceeds a predetermined value.

According to a further variant of the inventive method, the at least one invariant is allocated a constant target acceleration of the Tool Center Point during its movement. During the actual movement of the Tool Center Point along an actual path, the actual velocity and/or the time rate of change of the actual acceleration of the Tool Center Point can then be determined and evaluated as at least one derived value of the actual position of the Tool Center Point. The invariant is then not fulfilled if the actual acceleration of the Tool Center Point deviates by a predetermined value and/or the quantity of the time rate of change of the actual acceleration of the Tool Center Point exceeds a predetermined value.

According to a further variant of the inventive method, no assumptions are made about the total target path, but rather only about the local behavior of the target path. For example, a maximum permissible and reasonable curvature of the path can be assumed, along which the Tool Center Point is intended to move. If the curvature increases in one section, it may indicate a collision.

Based upon the target movement of the robot arm, the Tool Center Point is intended to move along a target path. During the actual movement of the robot arm, the Tool Center Point moves along an actual path.

According to one variant of the inventive method, the target path is a curved path. The invariant then indicates a maximum curvature of the curved path, such that a collision of the robot arm with the object is indicated if an evaluation of the signals from the position sensors shows that the curvature of the actual path exceeds a predetermined value.

According to a further embodiment of the inventive method, the target path is a circular path of the Tool Center Point with a predetermined curvature, and the invariant indicates the predetermined curvature. A collision of the robot arm with the object is then indicated if an evaluation of the signals from the position sensors shows that the curvature of the actual path deviates from the predetermined curvature by a predetermined value.

Additionally, the local curvature can be related to the velocity, such that the initiation of the safety function based upon a greater curvature only occurs if the velocity also exceeds a predetermined value. This means that relatively large curvatures are only permissible with relatively low velocities.

Thus, according to a further variant of the inventive method, a collision of the robot arm with the object is indicated additionally depending upon the velocity of the Tool Center Point during the movement along the actual path.

Figuratively speaking, one would attempt to pull the path through a short, straight tube. Starting from a certain curvature of the path, it would remain stuck in the tube. The maximum permissible curvature of the path can thus be defined by the length and diameter of the tube.

Instead of assuming a certain curvature or another value, the electronic control device can access the preconfigured values of the curvature, which can be defined, for example, as a component of an ESM (this is the acronym for “Event-driven Safety Monitoring,” i.e. a user-defined monitoring function).

A further invariant can be that the actual path cannot be pulled out backwards. Of the collisions that are oriented parallel to the path tangent, those that are oriented opposite to the direction of movement can thereby be detected.

### BRIEF DESCRIPTION OF THE DRAWINGS

The accompanying drawing, which is incorporated in and constitutes a part of this specification, illustrates an exemplary embodiment of the invention and, together with a general description of the invention given above, and the detailed description given below, serves to explain the principles of the invention.

FIG. 1 is a robot in a perspective view, and

FIG. 2 is a table.

### DETAILED DESCRIPTION

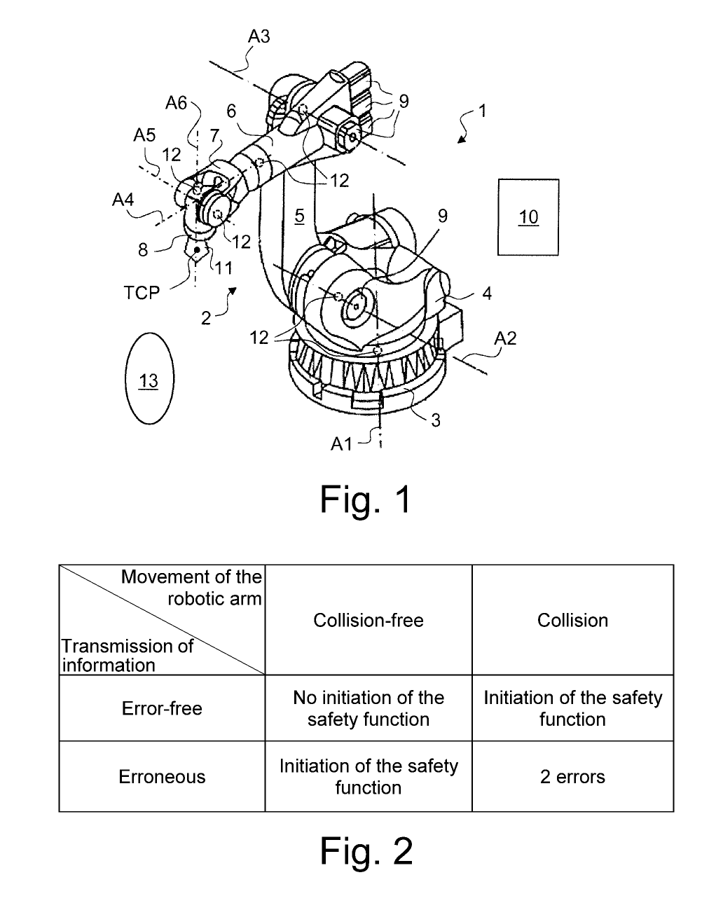

FIG. 1 shows a robot 1 comprising a robot arm 2 and an electronic control device 10. The robot arm 2 comprises multiple links arranged behind one another and connected using joints. The links are, in particular, a stationary or adjustable frame 3 and a carousel 4 mounted rotatably about an axis A1 which extends vertically relative to the frame 3. In the case of the present exemplary embodiment, further links of the robot arm 2 are a link arm 5, a boom arm 6, and a preferably multi-axial robot hand 7 with a fastening device configured, for example, as a flange 8 for fastening an end effector 11.

The link arm 5 is mounted at the bottom end to, for example, a pivot bearing head, not shown in greater detail, on the carousel 4 pivotably about a preferably horizontal axis of rotation A2. At the upper end of the link arm 5, the boom arm 6 is also mounted pivotably about a likewise preferably horizontal axis A3. At its end, said boom arm holds the robot hand 7 with its preferably three axes A4, A5, A6.

In order to move the robot 1 and its robot arm 2, said robot comprises actuators connected to the electronic control device 10 (robot control) in the generally known manner. The actuators are, in particular, electric actuators comprising the electric motors 9. At least the motors and the electric motors 9 are arranged and fastened in or on the robot arm 2. FIG. 1 shows only a few of the electric motors 9. The actuator[s] are preferably controlled electric actuators.

Power electronics of the electric actuators are arranged, for example, within a housing of a control cabinet, not shown in greater detail, in which, for example, the electronic control device 10 is also arranged. In the case of the present exemplary embodiment, the electric motors 9 are three-phase motors, for example three-phase synchronous motors. However, the power electronics can also be arranged in and/or on the robot arm 2. The electronic control device 10 comprises, for example, a processor, not shown in greater detail, and can also be configured as, for example, a computer.

In the case of the present exemplary embodiment, the electronic control device 10 is configured such that it comprises a first control functionality and a second control functionality. The first control functionality undertakes the object of a safety control, the second control functionality undertakes the remaining controls of the robot 1.

On the electronic control device 10, a computation program, a so-called user program, runs, using which the control device 10 controls the actuators in an automatic operation within the scope of the work object, such that, if so ordered, if the robot arm 2 and the flange 8 of the robot 1 and a Tool Center Point TCP allocated to the robot arm 2 perform a predetermined movement. This is performed, for example, by the second control functionality.

Based upon the target movement of the robot arm, the Tool Center Point is intended to move along a target path. During the actual movement of the robot arm, the Tool Center Point moves along an actual path.

It can also be provided that the electronic control device 10 also controls the end effector 11 fastened to the flange 8 using the user program in the normal operation of the robot 1.

The robot 1 and its robot arm 2 further comprise multiple position sensors 12 preferably configured as resolvers. In the case of the present exemplary embodiment, the position sensors 12 are configured in safe technology and are configured in order to determine the actual angle poses of any two neighboring links 3-8 relative to one another.

The position sensors 12 are connected to the electronic control device 10, such that said device can evaluate the signals emitted by the position sensors 12. In the case of the present exemplary embodiment, this occurs using the first control functionality.

In particular, at least one position sensors 12 is allocated to each of the axes A1-A6 such that, in the normal operation of the robot 1, the electronic control device 10 receives a notification regarding the actual angle poses of each of the links 3-8 of the robot arm 2 relative to its neighboring link 3-8 based upon the signals emitted by the position sensors 12. It is thus also possible, in particular, for the electronic control device 10 to determine the actual position and, if applicable, also the actual orientation of the Tool Center Points TCP in the frame.

It is also possible, for example through differentiation or repeated differentiation and derivation according to time or repeated derivation according to time of the determined actual position of the Tool Center Point TCP and/or the determined individual actual angle poses, for the electronic control device 10 to determine the current velocity, the current acceleration, and/or the change of the current acceleration of the Tool Center Point TCP and/or the individual links 3-8.

In the case of the present exemplary embodiment, the robot 1 and its electronic control device 10 are configured, during an actual movement of the robot arm 2, in particular during the movement of the Tool Center Point TCP along an actual path, to check, based upon the signals emitted by the position sensors 12, whether, based upon the actual angle poses and/or derived values of the actual angle poses, and/or based upon the actual position, and/or at least one derived value of the actual position of the Tool Center Point, at least one applicable invariant is fulfilled for the target movement of the robot arm allocated to the actual movement, and/or for the movement of the Tool Center Point TCP along the target web for the actual movement of the robot arm and/or for the movement of the Tool Center Points TCP along the actual path, respectively. If the invariant for the actual movement is not fulfilled, then the electronic control device 10 concludes that the robot arm 2 has collided with an object 13 and initiates a safety function of the robot.

In the case of the present exemplary embodiment, it can be provided that the invariant indicates that the target movement is jerk-free. The electronic control device 10 then indicates a collision of the robot arm 2 with an object 13 if the third derivation of the actual position of the Tool Center Point TCP according to time or a time rate of change of the actual acceleration of the Tool Center Point TCP exceeds a predetermined value. Alternatively, it is also possible for a collision of the robot arm 2 with the object 13 to be indicated if the third derivations of the actual angle poses according to time or a time rate of change of the actual accelerations of the actual angle poses exceed a predetermined value.

In the case of the present exemplary embodiment, it can be provided that the electronic control device 10 controls the robot arm 2 using an admittance or force control. The predetermined value can then depend upon the rigidity of the admittance or force control.

The electronic control device 10 can receive data based upon non-safe technology. These are processed with the second control functionality. Data used or produced for a control, for example, do not fulfill the criterion of safe data. These data are used, for example, for the current movement of the robot arm 2. These data and information thus cannot be evaluated in the safety control, because they originate from, for example, the non-safe user program. In some cases, however, it is nonetheless also possible, on the basis of available safe data regarding assumptions/models, to obtain the information in safe technology that is otherwise only available in the non-safe control.

According to a further configuration, a linear movement of the Tool Center Point TCP is allocated to the target movement of the robot arm 2.

In the case of the present exemplary embodiment, it can be provided that the target movement of the robot arm 2 occurs using a path planning performed by the electronic control device 10. This path planning is performed, in particular, using the second control functionality.

According to this embodiment, it can be provided that the second control functionality transmits a notification to the first control functionality that a planned linear movement of the Tool Center Point TCP is imminent. This notification comprises, in particular, information about the target start and target end point of the Tool Center Point, whereby the first control functionality receives as an invariant the notification that the target positions of the Tool Center Point of the imminent target movement will run on the straight lines determined by the target start and target end points. If at least one of the actual positions of the corresponding target position deviates from these straight lines by the predetermined value during the movement, then the first control functionality identifies the collision.

In addition to the collision detection, there is also the possibility of detecting an erroneous performance of the movement of the robot arm, i.e. also in the event that no collision has appeared but the robot arm does not move as expected. This is illustrated in the table shown in FIG. 2.

If the information transmission between the two control functionalities is error-free, a collision will be reliably detected, and no safety function will be initiated if no collision is detected.

By contrast, if the information transmission between the two control functionalities is erroneous, then the electronic control device 10 will identify a collision, even if there is none. If there additionally is a collision, then two errors will result.

It is thus ensured that no safety function is initiated only when the transmission between the two control functionalities is error-free and no collision has been indicated.

In the case of the present exemplary embodiment, it can also be provided that the electronic control device 10, in particular its first control functionality, evaluates the movement of the Tool Center Point TCP at the start of a movement, in order to obtain through extrapolation of this movement the target path.

In this case, it is provided, in particular, that no information is exchanged between the first and second control functionalities. At the start of the performance of the movement, for example in an acceleration phase, the first control functionality can record the movement of the Tool Center Point TCP or the links 3-8 at the start of an actual movement of a robot arm 2, during a preferably predetermined period of time, and extrapolate from this the future target movement of the robot arm 2. The basis of the extrapolation can be a notification of which types of path are possible in principle, for example linear paths or circular paths.

The extrapolation should preferably be completed before the velocity of the Tool Center Point TCP or the robot arm 2 becomes so high that potential collisions become dangerous.

In the case of the present exemplary embodiment, it can be provided that the target path is a curved path. The invariant then indicates a maximum curvature of the curved path, such that a collision of the robot arm 2 with the object 13 is indicated if an evaluation of the signals from the position sensors 12 shows that the curvature of the actual path exceeds a predetermined value.

It can also be provided that the target path of the Tool Center Point TCP is a circular path of the Tool Center Point TCP with a predetermined curvature, and the invariant indicates the predetermined curvature. A collision of the robot arm with the object is then indicated if an evaluation of the signals from the position sensors shows that the curvature of the actual path deviates from the predetermined curvature by a predetermined value.

Additionally, the local curvature can be related to the velocity, such that the initiation of the safety function based upon a greater curvature only occurs if the velocity also exceeds a predetermined value. This means that relatively large curvatures are only permissible with relatively low velocities.

A further invariant can be that the actual path cannot be pulled out backwards. Thereby, at least those collisions that are oriented parallel to the path tangent can be detected if they are oriented opposite to the direction of movement.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

1-12. (canceled)

13. A method for detecting a collision of a robot arm with an object, wherein the robot arm is a part of a robot that includes a plurality of serially arranged links mounted relative to respective axes, and position sensors assigned to the individual axes and provided for determining the positions of each two adjacent links relative to one another, wherein a tool center point is allocated to the robot arm and the robot further includes an electronic control device in communication with the position sensors, and drives controlled by the electronic control device for the automatic movement of the links of the robot arm relative to one another, the method comprising:
automatically moving the links controlled by the electronic control device, such that the robot arm performs an actual movement associated with a target movement of the robot arm;
during the actual movement of the robot arm with the electronic control device based upon the signals emitted by the position sensors, evaluating whether at least one invariant for the target movement of the robot arm is satisfied by the actual movement of the robot arm, based upon the actual poses and/or derived values of the actual poses of the links relative to one another, and/or based upon the actual position and/or at least one derived value of the actual position of the tool center point; and
when the evaluation results in a non-satisfaction of the at least one invariant, then:
indicating a collision of the robot arm with the object, and
initiating of a safety function of the robot, controlled by the electronic control device.

14. The method of claim 13, further comprising determining the target movement of the robot arm, wherein the target movement is determined by:
using a path planning performed by the electronic control device; or
evaluating, with the electronic control device, the movement of the tool center point or the links at the start of an actual movement of the robot arm, and extrapolating this movement in order to obtain the target movement of the robot arm.

15. The method of claim 13, wherein the invariant relates to whether the target movement is smooth, and wherein a collision of the robot arm with the object is indicated when:
the third derivative of the actual position of the tool center point according to time or a time rate of change of the actual acceleration of the tool center point exceeds a predetermined value; or
the third derivatives of the actual positions of the links relative to one another according to time or a time rate of change of the actual accelerations of the actual positions of the links relative to one another exceed a predetermined value.

16. The method of claim 15, further comprising operating the robot arm using admittance control or force control, wherein the predetermined value depends upon the rigidity of the admittance control or force control.

17. The method of claim 13, wherein:
the at least one invariant is associated with target positions of the tool center point during the target movement, the actual positions of the tool center point are evaluated during the actual movement of the robot arm, and the invariant is not satisfied if at least one of the actual positions deviates from the corresponding target position of the tool center point by a predetermined value; or
the at least one invariant is associated with target poses of the links relative to one another during the target movement, the actual poses of the links relative to one another are evaluated during the actual movement of the robot arm, and the invariant is not fulfilled if at least one of the actual poses deviates from the corresponding target pose by a predetermined value.

18. The method of claim 13, wherein:
the at least one invariant is associated with a constant target velocity of the tool center point during its movement, the actual velocity and/or the actual acceleration of the tool center point is determined and evaluated as at least one derived value of the actual position of the tool center point during the actual movement of the robot arm, and the invariant is not satisfied if the actual velocity of the tool center point deviates by a predetermined value and/or the magnitude of the actual acceleration of the tool center point exceeds a predetermined value; or
the at least one invariant is associated with a constant target acceleration of the tool center point during its movement, the actual acceleration and/or the time rate of change of the actual acceleration of the tool center point is determined and evaluated as at least one derived value of the actual position of the tool center point during the actual movement of the robot arm, and the invariant is not satisfied if the actual acceleration of the tool center point deviates by a predetermined value and/or the magnitude of the time rate of change of the actual acceleration of the tool center point exceeds a predetermined value.

19. The method of claim 13, wherein:
a linear movement of the tool center point is associated with the target movement of the robot arm; or
automatically moving the links comprises linearly moving the links of the robot arm based upon the target movement of the robot arm.

20. The method of claim 13, wherein the tool center point is intended to move along a target path based upon the target movement of the robot arm, and the tool center point moves along an actual path based upon the actual movement of the robot arm.

21. The method of claim 20, wherein:
the target path is a curved path of the tool center point and the invariant is associated with a maximum curvature of the curved path; and
a collision of the robot arm with the object is indicated if evaluation of the signals from the position sensors results in the curvature of the actual path exceeding a predetermined value.

22. The method of claim 20, wherein:
the target path is a circular path of the tool center point with a predetermined curvature and the invariant indicates the predetermined curvature; and
a collision of the robot arm with the object is indicated if evaluation of the signals from the position sensors shows that the curvature of the actual path deviates from the predetermined curvature by a predetermined value.

23. The method of claim 21, wherein the indication of a collision of the robot arm with the object further depends upon the velocity of the tool center point during the movement along the actual path.

24. The method of claim 22, wherein the indication of a collision of the robot arm with the object further depends upon the velocity of the tool center point during the movement along the actual path.

25. A robot comprising:
a robot arm having an assigned tool center point and which comprises a plurality of serially arranged links mounted relative to respective axes;
position sensors allocated to the respective axes and configured to determine angle settings of any two adjacent links relative to one another;
an electronic control device in communication with the position sensors; and
actuators controlled by the electronic control device for automatic movement of the links relative to one another;
wherein the electronic control device is configured to detect a collision of the robot arm with an object according to the method of claim 13.
